(19) United States
(12) Patent Application Publication
(10) Pub. No.: US 2009/0000324 A1
(43) Pub. Date: Jan. 1, 2009

(54) Non-engine powered air conditioning system for auto-vehicle

(76) Inventor: Hung Chia Cheng, Rowland Heights, CA (US)

Correspondence Address: DAVID AND RAYMOND PATENT FIRM, 108 N. YNEZ AVE., SUITE 128, MONTEREY PARK, CA, 91754, US

(21) Appl. No.: 11/823,450

(22) Filed: Jun. 26, 2007

(51) Int. Cl. F25D 9/00; B60K 16/00; F25B 27/00

(52) U.S. Cl. 62/235.1; 180/2.2; 62/236

(57) ABSTRACT

A non-engine powered air conditioning system includes a solar energy supply arrangement having a solar energy collector adapted for mounting to the auto-vehicle and a power storage electrically connecting to the solar energy collector for converting the solar energy into electrical energy, and an electrical compressor electrically connecting to the power storage, wherein the electrical compressor is adapted for generating a cooling air to an interior of the auto-vehicle. The non-engine powered air conditioning system allows the driver to pre-cool the auto-vehicle before driving when the auto-vehicle is exposed under intensive sunlight for a period of time to avoid the driver experiencing extremely high interior temperature in the vehicle. Therefore, the drive is able to operate the vehicle with his best physical condition. Adopting the air conditioning system is adapted to also avoid some environmental problems, such as air pollution and global warming effect.

### BACKGROUND OF THE INVENTION

1. Field of Invention

The present invention relates to an air conditioning system for an auto-vehicle, and more particularly to a non-engine powered air conditioning system for an auto-vehicle to generate a cooling effect when the engine is turned off.

2. Description of Related Arts

An automobile is a wheeled passenger vehicle that carries its own motor. The first vehicle to move under its own power was invented in 1769 and the auto-vehicle industry has been developed ever since. With more than two hundred years' development, modern vehicles not only provide basic function of transportation, but also try to make driving an enjoyment to attract more customers. One of the major problems while driving an auto-vehicle during summer time is that when the auto-vehicle has been parked outdoors without any effective shield, the interior temperature of the auto-vehicle becomes extremely high and drivers may feel very uncomfortable under this circumstance. Even though driving is convenient for most people, it is in fact a dangerous activity and every driver has to be in his best condition to operate the auto-vehicle to avoid car accident. If a driver is driving under an extremely hot circumstance, his physical and mental conditions may be adversely affected and may not be able to operate the auto-vehicle with his best performance, and a car accident may consequently occur. Thus, the purpose to solve the problem presented above is not only for the enjoyment in driving, but more importantly for the concern of safety.

When the interior of the auto-vehicle becomes extremely hot during summer time, the driver sometimes starts the vehicle first and lets the engine provide power to the air conditioning system to lower the interior temperature which usually takes a few minutes. In fact, the time for cooling down the interior temperature from an extremely high temperature to a comfortable driving temperature is way longer than the time what the driver expected. In other words, most drivers will not wait until the interior temperature drops to the comfortable driving temperature and will drive the vehicle under the uncomfortable driving temperature. In addition, this “pre-cool” process poses a problem of air pollution. When the vehicle is not moving but with its engine and air conditioning system on, it can generate more exhausted gas including carbon dioxide (CO₂) than it is moving. Recently, atmospheric CO₂ concentration level has been significantly increased that generates a more serious and dangerous problem of global warming which will bring the impact of extreme and severe climate on the earth and irreparable harms to our environment. Therefore, even though the “pre-cool” process may lower the interior temperature, it generates a much more serious and dangerous problem beyond our control and imagination. In addition, the “pre-cool” process may impose extra burden on the engine and lower the gas mileages of the vehicle.

To avoid experiencing extremely warm situation while getting into the vehicle, the driver would rather stay in the vehicle with the engine and air conditioning system on when he/she needs to wait for a short period of time to pick someone up. Like the “pre-cool” process, the vehicle will generate more exhausted gas when it is not moving but with the engine and air conditioning system on. In addition, extra burden is imposed on the engine to lower the gas mileages of the vehicle.

### SUMMARY OF THE PRESENT INVENTION

A main object of the present invention is to provide a non-engine powered air conditioning system for an auto-vehicle, which is adapted to generate a cooling effect when the engine is turned off. In other words, the interior of the vehicle will be pre-cooled before the engine is turned on such that the driver is able to drive the vehicle under a comfortable driving temperature for safety concern.

Another object of the present invention is to provide a non-engine powered air conditioning system for an auto-vehicle, which is powered free to be operated in responsive to the auto-vehicle. The non-engine powered air conditioning system of the present invention incorporates with a solar energy supply arrangement for collecting solar energy as a power source for operation such that the non-engine powered air conditioning system is environment friendly to minimize the pollution of the environment.

Another object of the present invention is to provide a non-engine powered air conditioning system for an auto-vehicle to avoid an extremely hot interior of the vehicle during summer time and provide a more enjoyable driving environment to the driver.

Another object of the present invention is to provide a non-engine powered air conditioning system for an auto-vehicle so that the driver's physical and mental conditions are not adversely affected by the extremely hot interior environment and the driver is able to operate the vehicle more safely under his or her best bodily conditions.

Another object of the present invention is to provide a non-engine powered air conditioning system for an auto-vehicle, such that when the driver parks the vehicle outside without any effective shield, this air conditioning system can be turned on to generate cooling air in the interior of the vehicle and the drive does not have to pre-cool the interior of the vehicle before driving, such that unnecessary exhausted gas can be reduced to protect the environment from air pollution and global warming effect.

Another object of the present invention is to provide a non-engine powered air conditioning system for an auto-vehicle so as to allow the drive to have an alternative to operate the air conditioning system. In other words, the driver can turn off the engine but still enjoy the air conditioning by using the present invention.

Accordingly, in order to accomplish the above objects, the present invention provides a non-engine powered air conditioning system for an auto-vehicle, comprising a solar energy supply arrangement and an electrical compressor.

The solar energy supply arrangement comprises a solar energy collector adapted for mounting to the auto-vehicle, wherein the solar energy collector has a collecting surface oriented for exposing in sunlight to collect solar energy, and a power storage electrically connecting to the solar energy collector for converting the solar energy into electrical energy and for storing the electrical energy.

The electrical compressor, which is a low-voltage compressor, is electrically connecting to the power storage, wherein the electrical compressor is adapted for generating a cooling air to an interior of the auto-vehicle via an air duct thereof, such that the electrical compressor is powered free to be operated in responsive to the auto-vehicle for providing a cooling effect to the interior thereof when an engine of the auto-vehicle is turned off.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of the non-engine powered air conditioning system according to a preferred embodiment of the present invention.

FIG. 2 is a top schematic view of the non-engine powered air conditioning system according to the above preferred embodiment of the present invention.

FIG. 3 illustrates the non-engine powered air conditioning system according to the above preferred embodiment of the present invention.

FIG. 4 illustrates the non-engine powered air conditioning system being installed in an auto-vehicle according to the above preferred embodiment of the present invention.

FIG. 5 is a front view of the non-engine powered air conditioning system being installed in an auto-vehicle according to the above preferred embodiment of the present invention.

FIG. 6 illustrates showing the non-engine powered air conditioning system being installed in a golf car according to the above preferred embodiment of the present invention.

FIG. 7 is a block diagram illustrating the non-engine powered air conditioning system incorporating with the existing air conditioning system of the auto-vehicle according to the above preferred embodiment of the present invention.

### DETAILED DESCRIPTION OF THE PREFERRED EMBODIMENT

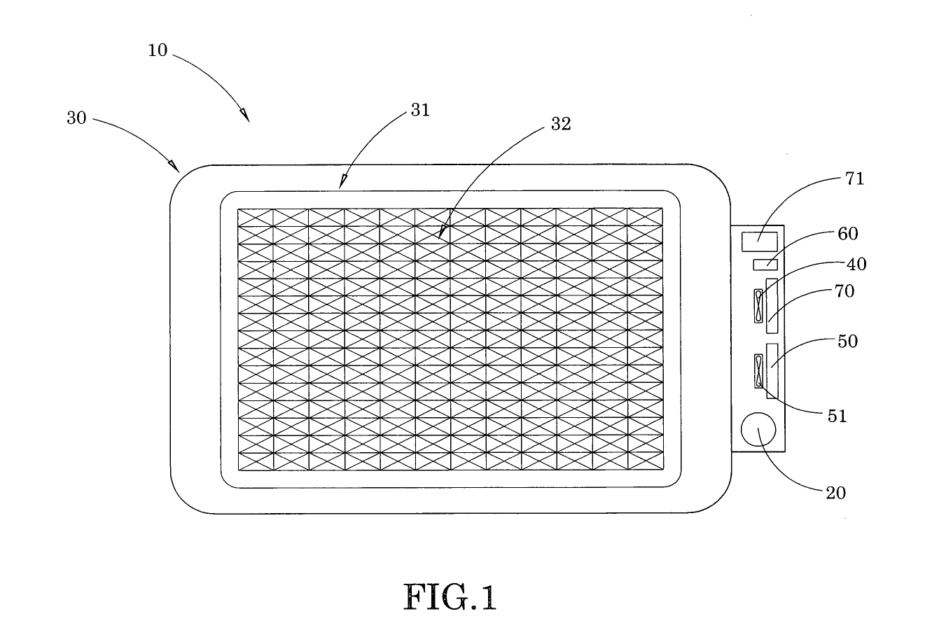

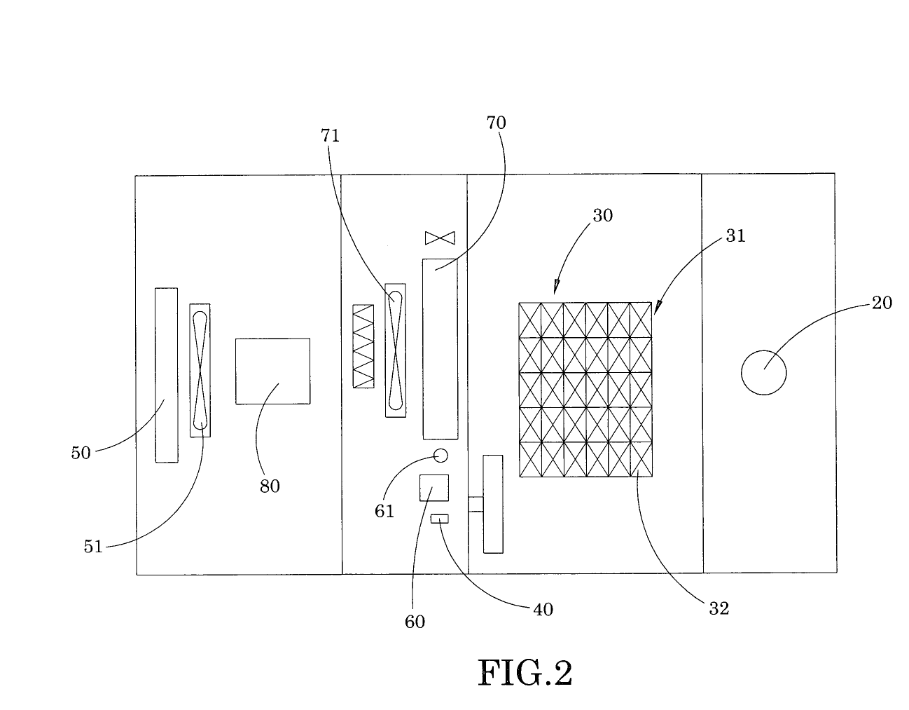

Referring to FIGS. 1 and FIG. 2, a non-engine powered air conditioning system for an auto-vehicle comprises a solar energy supply arrangement 10 and an electrical compressor 20.

The solar energy supply arrangement 10 comprises a solar energy collector 30 adapted for mounting to the auto-vehicle, wherein the solar energy collector 30 has a collecting surface 31 oriented for exposing in sunlight to collect solar energy. Accordingly, the solar energy collector 30 comprises one or more solar energy collecting panels 32 having the collecting surface 31 thereon mounted on a roof of the auto-vehicle to collect the solar energy. Accordingly, the solar energy collecting panels 32 can be mounted to the entire roof of the auto-vehicle for maximizing the collection of solar energy. Alternatively, the solar energy collecting panels 32 can be installed into the “sunroof” or “moon roof” of the auto-vehicle such that the “sunroof” or “moon roof” of the existing auto-vehicle can be replaced by the solar energy collecting panels 32 to incorporate the solar energy collecting panels 32 with the existing auto-vehicle.

The solar energy supply arrangement 10 also comprises a power storage 40 electrically connecting to the solar energy collector 30 for converting the solar energy into electrical energy and for storing the electrical energy.

The electrical compressor 20, which is a low-voltage compressor, is electrically connecting to the power storage 40, wherein the electrical compressor 20 is adapted for generating a cooling air to an interior of the auto-vehicle through an air duct thereof. More specifically, the essential power for the electrical compressor 20 is from the power storage 40 electrically connecting to the solar energy collector 30, so even the engine 80 of the auto-vehicle is turned off, the electrical compressor 20 can still provide a cooling effect to the interior of the auto-vehicle incorporating with a condenser 50 and a fan 51.

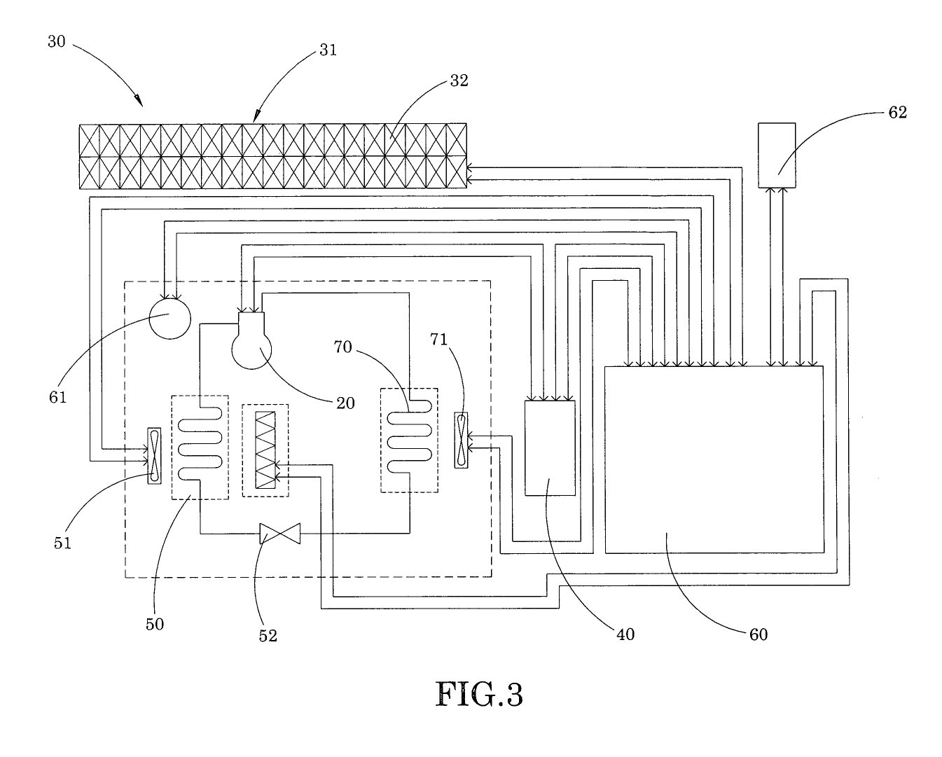

A thermal control 60 is arranged for controlling an interior temperature of the auto-vehicle, wherein the thermal control 60 comprises a thermal sensor 61 for detecting the interior temperature of the auto-vehicle and a thermal switch 62 electrically connected to the thermal control 60 and the electrical compressor 20 for operatively controlling a cooling level of the cooling air generated from the electrical compressor 20, as shown in FIG. 3. When the engine of the auto-vehicle is turned off and a thermal sensor 61 detects that the interior temperature of the auto-vehicle is higher than a preset temperature, the detected signal is transmitted to the thermal control 60 which immediately turns on the thermal switch 62 to activate the electrical compressor 20 as well as the entire air-conditioning system (including the condenser 50, the fan 51, a expansion valve 52, and a evaporator 70) to generate the cooling air so as to maintain the interior temperature of the auto-vehicle at a preset temperature. Meanwhile, the power to activate the electrical compressor 20 and the entire air conditioning system is provided by the power storage 40 electrically connecting to the solar energy collector 30 for converting the solar energy into electrical energy and for storing the electrical energy.

When the interior temperature of the auto-vehicle is equal or slightly lower than the preset temperature, a signal is sent from the thermal sensor 61 to the thermal control 60 to turn off the thermal switch 62 to deactivate the electrical compressor 20 as well as the entire air conditioning system.

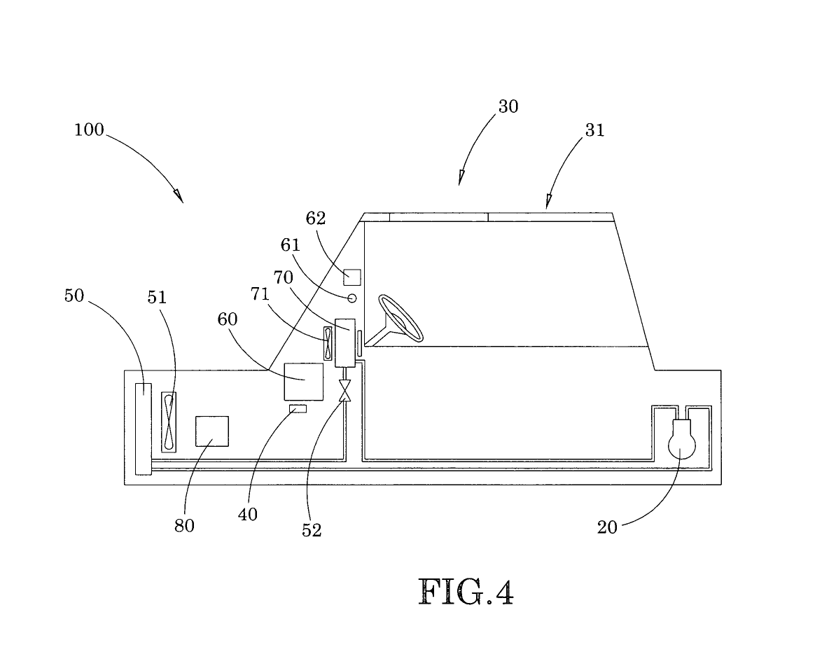

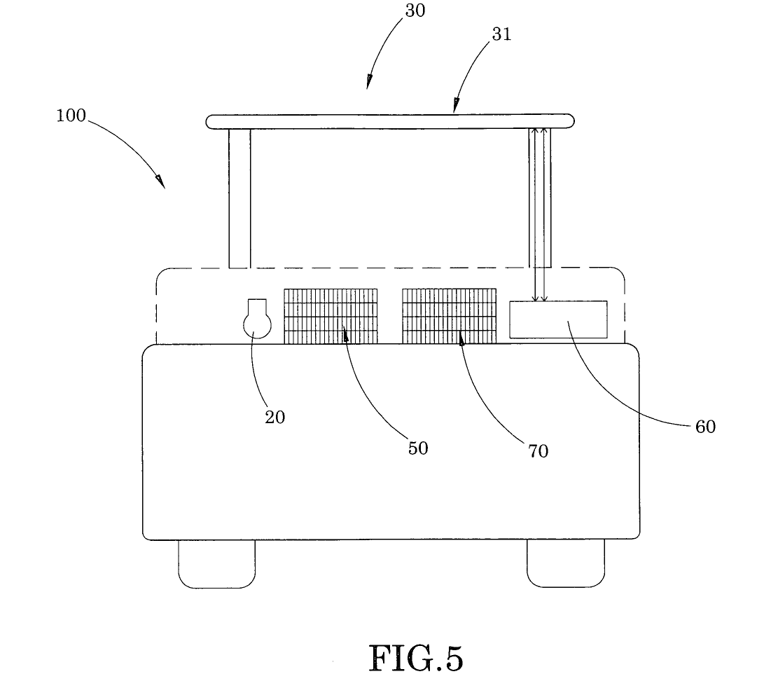

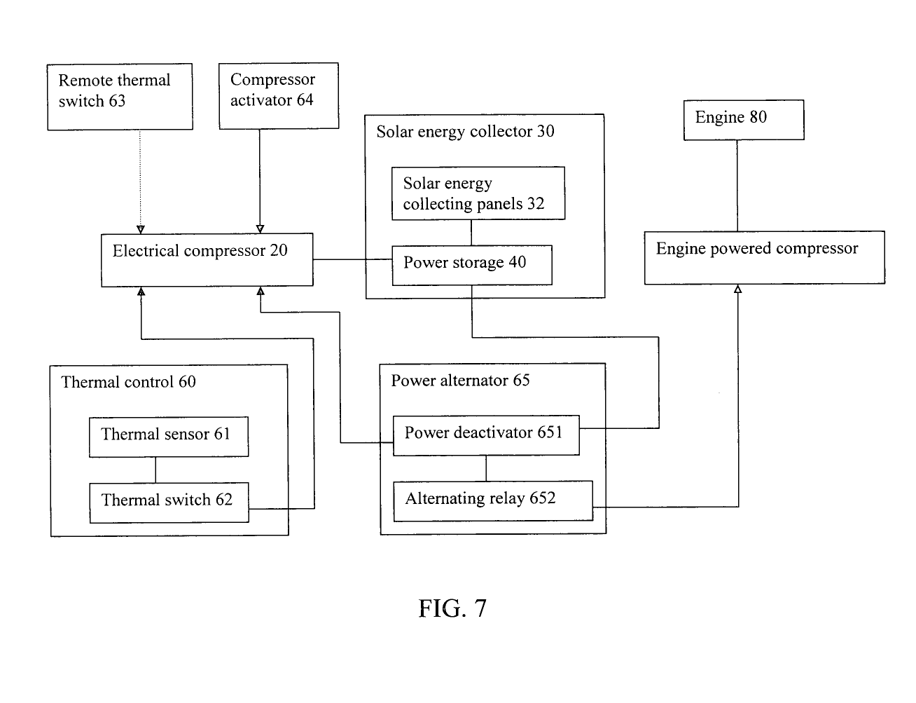

As shown in FIG. 4 and FIG. 5, an auto-vehicle 100 comprises an engine 80, wherein the non-engine powered air conditioning system is adapted to incorporate with the engine powered compressor of the auto-vehicle 100 to form a dual air condition system as shown in FIG. 7. The non-engine powered air conditioning system comprises the electrical compressor 20, the solar energy collector 30 along with the collecting surface 31 mounted on the roof of the auto-vehicle, the power storage 40, the fans 51 and 71, along with the condenser 50 and the evaporator 70 respectively. The non-engine powered air conditioning system also includes the thermal control 60, comprising the thermal sensor 61 and the thermal switch 62. The functions of the non-engine powered air conditioning system are identical as stated above.

During summer time, when the drive turns off the engine and parks the auto-vehicle under sunlight without effective shield, he can turn on non-engine powered air conditioning system. When the thermal sensor 61 detects that the interior temperature of the auto-vehicle is higher than the preset temperature, the detected signal is transmitted to the thermal control 60 which immediately turns on the thermal switch 62 to activate the electrical compressor 20 as well as the entire air-conditioning system including the condenser 50, the fan 51, a expansion valve 52, and an evaporator 70 to generate the cooling air so as to maintain the interior temperature of the auto-vehicle at a preset temperature. Meanwhile, the power to activate the electrical compressor 20 and the entire air conditioning system is provided by the power storage 40 electrically connecting to the solar energy collector 30 for converting the solar energy into electrical energy and for storing the electrical energy. It is worth to mention that during the summer time, the solar energy collector 30 is adapted for collecting enough solar energy to be converted into the electrical energy as a power source in order to supply the electrical energy to the electrical compressor 20. Therefore, it is a hassle free for the driver to worth about the insufficient power to operate the electrical compressor 20 during the summer time.

When the interior temperature of the auto-vehicle is equal or slightly lower than the preset temperature, a signal is sent from the thermal sensor 61 to the thermal control 60 to turn off the thermal switch 62 to deactivate the electrical compressor 20 as well as the entire air conditioning system. Thus, when the driver comes back to the auto-vehicle, the interior temperature remains almost consistent with the preset temperature and the drive will not experience the extremely hot interior of the auto-vehicle as previously stated and most importantly, the driver's driving capability will not be impaired due to the extremely warm interior condition. Once the driver starts the engine 80, he or she is able to turn on the existing air conditioning system to keep the interior temperature constantly. It is worth to mention that since the interior of the auto-vehicle is pre-cooled by the non-engine powered air conditioning system of the present invention, the time for the existing air conditioning system to constantly keep the interior temperature will be relatively shortened. Therefore, less power consumption of engine 80 is required to operate the existing air condition system.

According to the preferred embodiment, the driver can remotely control the non-engine powered air conditioning system via a remote thermal switch 63 without turning on the system when leaving and parking the vehicle. Accordingly, the remote thermal switch 63 is electrically connecting to the electrical compressor 20 to selectively and remotely control the electrical compressor 20 in an on and off manner for pre-cooling the interior of the auto-vehicle before the engine 80 thereof is turned on. If the drive is not far away from the vehicle, he can remotely turn on the non-engine powered air conditioning system a few minutes before he gets into the vehicle. Namely, he can “pre-cool” the vehicle to avoid the extremely warm interior condition before he tries to drive again. Furthermore, since this pre-cool process is activated by the non-engine powered air conditioning system, the environmental problems such as air pollution, or even worse global warming effect as previously described, can be totally avoided.

As shown in FIG. 7, the non-engine powered air conditioning system further comprises a compressor activator 64 for manually activating the electrical compressor 20, wherein the compressor activator 64 operatively connecting to the electrical compressor 20 and is arranged for activating the electrical compressor 20 when the engine 80 of the auto-vehicle is turned on. Therefore, the driver optionally turns on the electrical compressor 20 manually to selectively generate the cooling air by the non-engine powered air conditioning system during driving. Accordingly, while driving the auto-vehicle, the drive has two options to operate the air conditioning system. Namely, the drive can either use the existing air conditioning system powered by the engine or the non-engine powered air conditioning system of the present invention. Traditionally, the air conditioning system increases the burden of the engine 80 and decreases the gas mileages of the vehicle. If the driver sometimes uses the non-engine powered air conditioning system instead, the burden of the engine 80 is decreased and the vehicle is thus able to use the gas more efficiently, which is an important concern at the present time when the gas price is skyrocketing.

The non-engine powered air conditioning system further comprises a power alternator 65 for operatively deactivating the electrical compressor 20, wherein the power alternator 65 comprises a power deactivator 651 which is operatively connecting to the power storage 40 and is arranged for deactivating the electrical compressor 20 when a level of the electrical energy in the power storage 40 is low, and an alternating relay 652 electrically connecting to the power deactivator 651 for switching on the engine powered compressor of the auto-vehicle when the electrical compressor 20 is deactivated by the power deactivator 651. Accordingly, when the energy level of the power storage 40 is low, the driver may not able to activate the electrical compressor 20 during driving. Therefore, once the power deactivator 651 detects the energy level of the electrical compressor 20 is below a predetermined threshold, the alternating relay 652 will automatically deactivate the electrical compressor 20 and activate the engine powered compressor for keep generating the cooling effect for the interior of the auto-vehicle. It is worth to mention that the power alternator 65 will only be activated when the engine 80 is turned on. Once the engine 80 is turned off, only the non-engine powered air conditioning system of the present invention is adapted to be selected to operate.

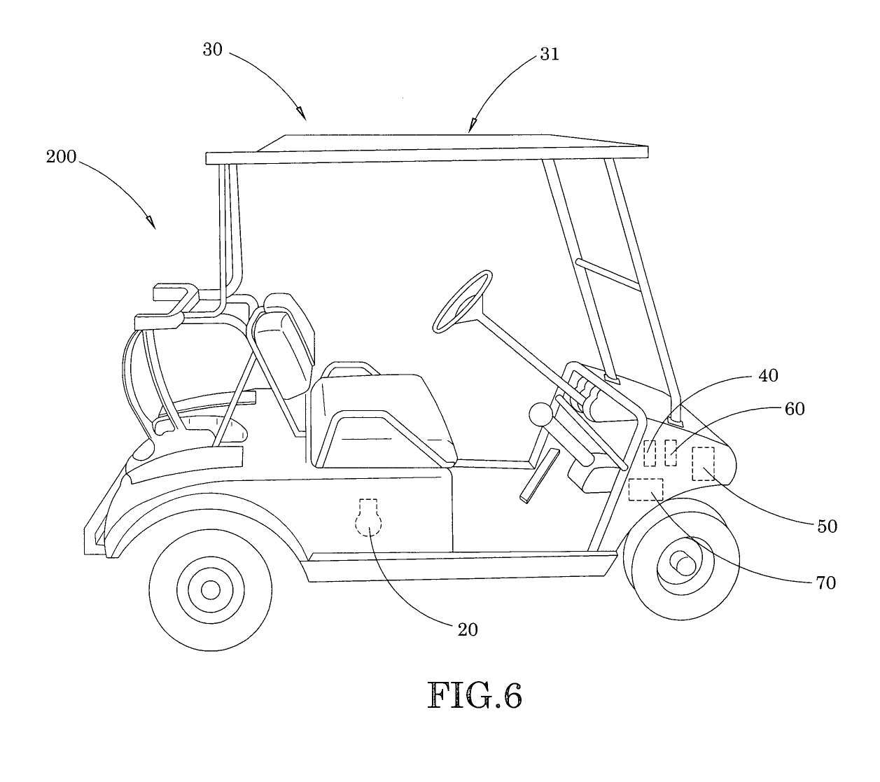

In a preferred embodiment, the non-engine powered air conditioning system can be simply installed in a golf car as an example to illustrate the use of the present invention. Golf players sometimes play under intensive sunlight and the golf car usually is not equipped with an air conditioning system. When the weather is extremely hot, golf players have to suffer from the hot weather and the performance may be impaired due to the unpleasant weather. As a schematic view in FIG. 6, the golf car comprises the non-engine powered air conditioning system including the electrical compressor 20, the solar energy collector 30 along with the collecting surface 31 mounted on the roof of the auto-vehicle, the power storage 40, the fan 51 and expansion valve 52 embedded in the condenser 50, and the evaporator 70. The thermal sensor 61 and the thermal switch 62 are also embedded in the thermal control 60. The functions of the non-engine powered air conditioning system are identical as stated above.

When golf players get into the golf car and turn on the non-engine powered air conditioning system, the electrical compressor 20 is then activated as well as the entire air-conditioning system including the condenser 50, the fan 51, an expansion valve 52, and an evaporator 70 to generate the cooling air to lower the ambient temperature. Meanwhile, the power to activate the electrical compressor and the entire air conditioning system is provided by the power storage 40 electrically connecting to the solar energy collector 30 for converting the solar energy into electrical energy and for storing the electrical energy. Thus, gold players can also enjoy cooling air while playing under extensive sunlight, such that gold players will enjoy the game more and have better performance.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A non-engine powered air conditioning system for an auto-vehicle, comprising:
a solar energy supply arrangement, which comprises:
a solar energy collector adapted for mounting to said auto-vehicle, wherein said solar energy collector has a collecting surface orientated for exposing in sunlight to collect solar energy; and
a power storage electrically connecting to said solar energy collector for converting said solar energy into electrical energy and for storing said electrical energy; and
an electrical compressor, which is a low-voltage compressor, electrically connecting to said power storage, wherein said electrical compressor is adapted for generating a cooling air to an interior of said auto-vehicle via an air duct thereof, such that said electrical compressor is powered free to be operated in responsive to said auto-vehicle for providing a cooling effect to said interior thereof when an engine of said auto-vehicle is turned off.

2. A non-engine powered air conditioning system, as recited in claim 1, wherein said solar energy supply arrangement further comprises a thermal control for controlling an interior temperature of said auto-vehicle, wherein said thermal control comprises a thermal sensor for detecting said interior temperature of said auto-vehicle and an auto-thermal switch electrically connecting to said electrical compressor for operatively controlling a cooling level of said cooling air generated from said electrical compressor so as to maintain said interior temperature of said auto-vehicle at a preset temperature when said engine of said auto-vehicle is turned off.

3. The non-engine powered air conditioning system, as recited in claim 1, wherein said solar energy supply arrangement further comprises a remote thermal switch electrically connecting to said electrical compressor to selectively and remotely control said electrical compressor in an on and off manner for pre-cooling said interior of said auto-vehicle before said engine thereof is turned on.

4. The non-engine powered air conditioning system, as recited in claim 2, wherein said solar energy supply arrangement further comprises a remote thermal switch electrically connecting to said electrical compressor to selectively and remotely control said electrical compressor in an on and off manner for pre-cooling said interior of said auto-vehicle before said engine thereof is turned on.

5. The non-engine powered air conditioning system, as recited in claim 1, wherein said solar energy collector comprises one or more solar energy collecting panels defining said collecting surface thereon, wherein said solar energy collecting panels are adapted for mounting on a roof of said auto-vehicle to collect said solar energy.

6. The non-engine powered air conditioning system, as recited in claim 4, wherein said solar energy collector comprises one or more solar energy collecting panels defining said collecting surface thereon, wherein said solar energy collecting panels are adapted for mounting on a roof of said auto-vehicle to collect said solar energy.

7. The non-engine powered air conditioning system, as recited in claim 1, further comprising a compressor activator for manually activating said electrical compressor, wherein said compressor activator operatively connecting to said electrical compressor and is arranged for activating said electrical compressor when said engine of said auto-vehicle is turned on.

8. The non-engine powered air conditioning system, as recited in claim 6, further comprising a compressor activator for manually activating said electrical compressor, wherein said compressor activator operatively connecting to said electrical compressor and is arranged for activating said electrical compressor when said engine of said auto-vehicle is turned on.

9. The non-engine powered air conditioning system, as recited in claim 1, further comprising a power alternator for operatively deactivating said electrical compressor, wherein said power alternator comprises a power deactivator which is operatively connecting to said power storage and is arranged for deactivating said electrical compressor when a level of said electrical energy in said power storage is low, and an alternating relay electrically connecting to said power deactivator for switching on an engine powered compressor of said auto-vehicle when said electrical compressor is deactivated by said power deactivator.

10. The non-engine powered air conditioning system, as recited in claim 8, further comprising a power alternator for operatively deactivating said electrical compressor, wherein said power alternator comprises a power deactivator which is operatively connecting to said power storage and is arranged for deactivating said electrical compressor when a level of said electrical energy in said power storage is low, and an alternating relay electrically connecting to said power deactivator for switching on an engine powered compressor of said auto-vehicle when said electrical compressor is deactivated by said power deactivator.

11. A method of controlling an interior temperature of an auto-vehicle, comprising the steps of:
(a) storing electrical energy in a power storage, wherein said electrical energy is converted from solar energy;
(b) providing said electrical energy to an electrical compressor from said power storage to generate a cooling air to an interior of said auto-vehicle, such that said electrical compressor is powered free to be operated in responsive to said auto-vehicle for providing a cooling effect to said interior thereof when an engine of said auto-vehicle is turned off;
(c) keep operating said electrical compressor to maintain said interior temperature of said auto-vehicle at a preset temperature.

12. The method, as recited in claim 11, wherein the step (c) further comprises the steps of:
(c.1) detecting said interior temperature of said auto-vehicle via a thermal sensor; and
(c.2) operatively controlling a cooling level of said cooling air generated from said electrical compressor to maintain said interior temperature of said auto-vehicle at said preset temperature.

13. The method, as recited in claim 11, wherein the step (b) further comprises a step of remotely controlling said electrical compressor in an on and off manner to pre-cool said interior of said auto-vehicle before said engine thereof is turned on.

14. The method, as recited in claim 12, wherein the step (b) further comprises a step of remotely controlling said electrical compressor in an on and off manner to pre-cool said interior of said auto-vehicle before said engine thereof is turned on.

15. The method, as recited in claim 11, wherein the step (a) further comprises the steps of:
(a.1) providing one or more solar energy collecting panels on a roof of said auto-vehicle, wherein each of said solar energy collecting panels is orientated for exposing in sunlight to collect said solar energy; and
(a.2) converting said solar energy collected from said solar energy collecting panels into said electrical energy to be stored in said power storage.

16. The method, as recited in claim 15, wherein the step (a) further comprises the steps of:
(a.1) providing one or more solar energy collecting panels on a roof of said auto-vehicle, wherein each of said solar energy collecting panels is orientated for exposing in sunlight to collect said solar energy; and
(a.2) converting said solar energy collected from said solar energy collecting panels into said electrical energy to be stored in said power storage.

17. The method as recited in claim 11 wherein, in the step (b), said electrical compressor is manually activated for generating said cooling air when said engine of said auto-vehicle is turned on.

18. The method as recited in claim 16 wherein, in the step (b), said electrical compressor is manually activated for generating said cooling air when said engine of said auto-vehicle is turned on.

19. The method as recited in claim 11 wherein, in the step (c), said electrical compressor is deactivated when a level of said electrical energy in said power storage is low.

20. The method as recited in claim 18 wherein, in the step (c), said electrical compressor is deactivated when a level of said electrical energy in said power storage is low.

21. An auto-vehicle, comprising:
an engine;
a solar energy supply arrangement, which comprises:
a solar energy collector mounting to a roof of said auto-vehicle, wherein said solar energy collector has a collecting surface orientated for exposing in sunlight to collect solar energy; and
a power storage electrically connecting to said solar energy collector for converting said solar energy into electrical energy and for storing said electrical energy; and
a dual-powered air conditioning system, which comprises:
an engine-powered compressor powered by said engine for generating a cooling air to an interior of said auto-vehicle via an air duct thereof; and
an electrical compressor, which is a non-engine powered compressor, electrically connecting to said power storage, wherein said electrical compressor is adapted for generating said cooling air to said interior of said auto-vehicle via said air duct thereof, such that said electrical compressor is powered free to be operated in responsive to said engine for providing a cooling effect to said interior thereof when said engine of said auto-vehicle is turned off.

22. The auto-vehicle, as recited in claim 21, wherein said solar energy supply arrangement further comprises a thermal control for controlling an interior temperature of said auto-vehicle, wherein said thermal control comprises a thermal sensor for detecting said interior temperature of said auto-vehicle and an auto-thermal switch electrically connecting to said electrical compressor for operatively controlling a cooling level of said cooling air generated from said electrical compressor so as to maintain said interior temperature of said auto-vehicle at a preset temperature when said engine of said auto-vehicle is turned off.

23. The auto-vehicle, as recited in claim 22, wherein said solar energy supply arrangement further comprises a remote thermal switch electrically connecting to said electrical compressor to selectively and remotely control said electrical compressor in an on and off manner for pre-cooling said interior of said auto-vehicle before said engine thereof is turned on.

24. The auto-vehicle, as recited in claim 25, wherein said solar energy collector comprises one or more solar energy collecting panels defining said collecting surface thereon, wherein said solar energy collecting panels are mounted on said roof of said auto-vehicle to collect said solar energy.

25. The auto-vehicle, as recited in claim 24, further comprising a compressor activator for manually activating electrical compressor, wherein said compressor activator operatively connecting to said electrical compressor and is arranged for activating electrical compressor when said engine of said auto-vehicle is turned on.

26. The auto-vehicle, as recited in claim 25, further comprising a power alternator for operatively deactivating said electrical compressor, wherein said power alternator comprises a power deactivator which is operatively connecting to said power storage and is arranged for deactivating said electrical compressor when a level of said electrical energy in said power storage is low, and an alternating relay electrically connecting to said power deactivator for switching on an engine powered compressor of said auto-vehicle when said electrical compressor is deactivated by said power deactivator.
